(19) United States
(12) Patent Application Publication
(10) Pub. No.: US 2013/0100342 A1
(43) Pub. Date: Apr. 25, 2013

(54) IMAGE CAPTURING DEVICE

(71) Applicant: LITE-ON TECHNOLOGY CORP., TAIPEI (TW)

(72) Inventor: MENG-HSIN KUO, TAIPEI (TW)

(73) Assignee: LITE-ON TECHNOLOGY CORP., TAIPEI (TW)

(21) Appl. No.: 13/707,949

(22) Filed: Dec. 7, 2012

Related U.S. Application Data
(63) Continuation-in-part of application No. 12/782,146, filed on May 18, 2010.

(30) Foreign Application Priority Data
Dec. 15, 2009 (TW) 098142868

(51) Int. Cl. H04N 5/225

(52) U.S. Cl. CPC H04N 5/2254
USPC 348/374

(57) ABSTRACT

An image capturing device includes a base defining a receiving space and having two spaced-apart through holes, first and second lens units disposed within the receiving space, a circuit board connected to a bottom end of the base, and two sensor elements disposed on a top face of the circuit board below the first and second lens units. The first lens unit defines a first light communicating path corresponding in position with one of the through holes. The second lens unit defines a second light communicating path corresponding in position with the other through hole. The first and second lens units and the sensor elements are inclined inwardly, so that the first and second light communicating paths intersect each other in an extended direction and in the area external to the base.

### CROSS-REFERENCE TO RELATED APPLICATION

This Application is being filed as a Continuation-in-Part of U.S. patent application Ser. No. 12/782,146 (hereinafter referred to as the '146 application), filed 18 May 2010, currently pending, and claiming priority of Taiwanese Application No. 098142868, filed 15 Dec. 2009.

### BACKGROUND OF THE INVENTION

1. Field of the Invention

This invention relates to an image capturing device, more particularly to an image capturing device having two lens units respectively defining light communicating paths.

2. Description of the Related Art

Referring to FIGS. 1 and 2, currently, to determine the coordinate position of an object in a three dimensional space, at least two spaced-apart image capturing devices 1, 1′ are required to perform an image capturing operation. Both of the two image capturing devices 1, 1′ are assembled on an electronic device (not shown). Each image capturing device 1, 1′ includes a base 11, a lens unit 12 fixed within the base 11, a circuit board 13 welded to a bottom end of the base 11, and a sensor element 14 provided on a top face of the circuit board 13 and spaced apart from and disposed below the lens unit 12. Two intersecting lines (A) passing through the lens unit 12 of the image capturing device 1 define therebetween a viewable region (A1) of the image capturing device 1. Two intersecting lines (B) passing through the lens unit 12 of the image capturing device 1′ define therebetween a viewable region (B1) of the image capturing device 1′. An image of an object 2 located on an overlapping region (C) of the viewable regions (A1, B1) is simultaneously formed on the sensor elements 14 of the two image capturing devices 1, 1′.

For example, when the object 2 moves from a first position (D1) to a second position (D2), or from the second position (D2) to a third position (D3), the position of the image of the object 2 formed on the sensor element 14 through the lens unit 1 is varied. The sensor elements 14 of the two image capturing devices 1, 1′ transmit the captured image data to a computing unit (not shown) of the electronic device through the circuit board 13 so as to differentiate between the coordinate position and the change in the coordinate position of the object 2 in three dimensional space.

Since the image capturing devices 1, 1′ have to be manufactured separately, after which they are assembled on the electronic device, the assembly process is time-consuming, the manufacturing cost thereof is increased, and the electronic device must provide a large space to accommodate assembly of the two image capturing devices 1, 1′ thereto. Further, the components of each image capturing device 1, 1′ have specific assembly tolerances after the assembly, so that accuracy between the lens units 12 of the two image capturing devices 1, 1′ after their assembly on the electronic device cannot be easily controlled.

### SUMMARY OF THE INVENTION

Therefore, the main object of the present invention is to provide an image capturing device having two lens units respectively defining light communicating paths, so that assembly efficiency and accuracy may be enhanced, and the manufacturing cost thereof can be reduced to a minimum.

The purpose of the present invention and the solution to the conventional technical problems are achieved through employment of the below technical means. According to the disclosure of the present invention, an image capturing device comprises a base, first and second lens units, a circuit board, and two spaced-apart sensor elements. The base defines a receiving space and has two spaced-apart through holes for fluid communication of the receiving space with an area external to the base. The first lens unit is disposed within the receiving space and defines a first light communicating path that corresponds in position with one of the through holes. The second lens unit is disposed within the receiving space in a side-by-side manner with the first lens unit, and defines a second light communicating path that corresponds in position with the other one of the through holes. The circuit board is connected to a bottom end of the base. The two sensor elements are disposed on a top face of the circuit board and are spaced apart from and disposed below the first and second lens units. The sensor elements are used to detect light rays that pass through the first and second light communicating paths, respectively. The first and second lens units and the sensor elements are inclined inwardly, so that the first and second light communicating paths intersect each other in an extended direction and in the area external to the base.

Through the aforesaid technical means, the advantages and efficacy of the image capturing device of the present invention reside in the first and second lens units thereof which are arranged in a side-by-side manner and which respectively define first and second light communicating paths, so that the sensor elements can detect light rays passing through the first and second light communicating paths, respectively. Hence, steps of assembly can be reduced so as to shorten the assembly time, thereby reducing the manufacturing costs thereof to a large extent. Further, assembly and positioning precision of the first and second lens units can be effectively enhanced, so that accuracy of the image capturing device after assembly on the electronic device may also be enhanced.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of two conventional image capturing devices;

FIG. 2 is a schematic view, illustrating how the two conventional image capturing devices form an image of an object;

FIG. 3 is a sectional view of an image capturing device according to the first preferred embodiment of this invention, illustrating first and second lens units being spaced apart from each other in a left-right manner within a base;

FIG. 4 is a view similar to FIG. 3, illustrating how the image capturing device of the first preferred embodiment forms an image of an object;

FIG. 5 is a sectional view of the image capturing device of the first preferred embodiment, illustrating the first and second lens units being connected integrally to each other as one piece;

FIG. 6 is a sectional view of an image capturing device according to the second preferred embodiment of this invention, illustrating two sensor elements disposed below first and second lens units being spaced apart from each other in a left-right manner;

FIG. 7 is a sectional view of the image capturing device of the second preferred embodiment, illustrating the first and second lens units being connected integrally to each other as one piece;

FIG. 8 is a sectional view of an image capturing device according to the third preferred embodiment of this invention, illustrating first and second lens units and sensor elements being inclined inwardly, and the first and second lens units being spaced apart from each other in a left-right manner;

FIG. 9 is a view similar to FIG. 8, but illustrating how the image capturing device of the third preferred embodiment forms an image of an object, and further illustrating first and second light communicating paths intersecting each other in an extended direction and in an area external to a base;

FIG. 10 is a sectional view of the image capturing device of the third preferred embodiment, illustrating the first and second lens units being connected integrally to each other as one piece;

FIG. 11 is a sectional view of the third preferred embodiment, illustrating each of the first and second lens units including a single lens;

FIG. 12 is a sectional view of the third preferred embodiment, illustrating each of the first and second lens units including a plurality of lenses;

FIG. 13 is a sectional view of the third preferred embodiment, illustrating the number of lenses of the first and second lens units being different; and

FIG. 14 is a sectional view of the third preferred embodiment, illustrating the first and second lens units having different shapes;

FIG. 15 is a sectional view of an image capturing device according to the fourth preferred embodiment of this invention, illustrating first and second lens units being spaced apart from each other in a left-to-right manner;

FIG. 16 is a sectional view of the image capturing device of the fourth preferred embodiment, illustrating the first and second lens units being connected integrally to each other as one piece;

FIG. 17 is a sectional view of an image capturing device according to the fifth preferred embodiment of this invention, illustrating first and second lens units being spaced apart from each other in a left-to-right manner;

FIG. 18 is an exploded perspective view of two wafers used in the manufacture of the image capturing device of the fifth preferred embodiment;

FIG. 19 is a schematic view, illustrating the two wafers of FIG. 18 in an overlapping manner and how each set of the first and second lens units and a sensor element can be cut from the two overlapping wafers; and

FIG. 20 is a sectional view of the image capturing device of the fifth preferred embodiment, illustrating the first and second lens units being connected integrally to each other as one piece.

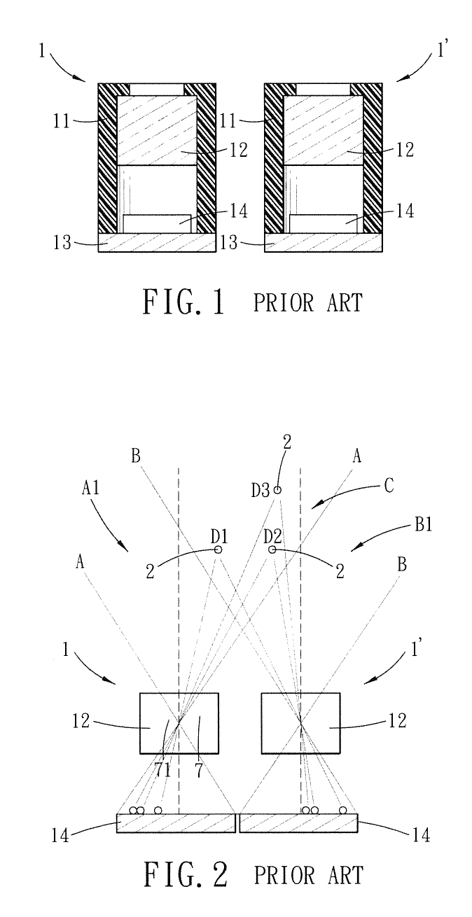

### DETAILED DESCRIPTION OF THE PREFERRED EMBODIMENTS

The above-mentioned and other technical contents, features, and effects of this invention will be clearly presented from the following detailed description of five preferred embodiments in cooperation with the reference drawings. Through description of the concrete implementation method, the technical means employed and the efficacy to achieve the predetermined purpose of the present invention will be thoroughly and concretely understood. However, the enclosed drawings are used for reference and description only, and are not used for limiting the present invention.

Before this invention is described in detail, it should be noted that, in the following description, similar elements are designated by the same reference numerals.

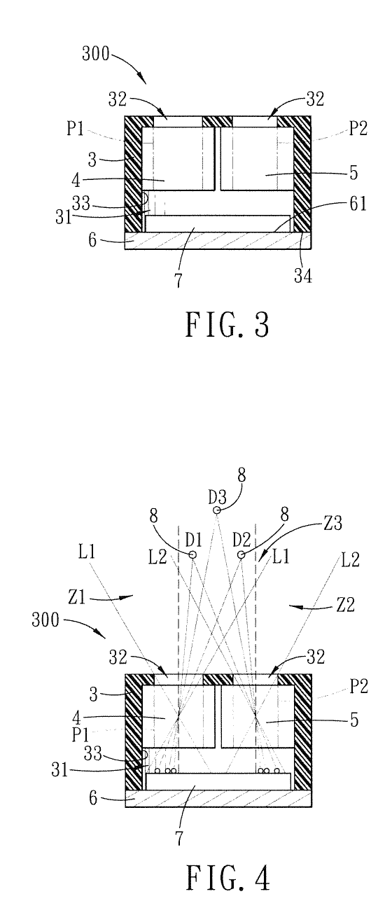

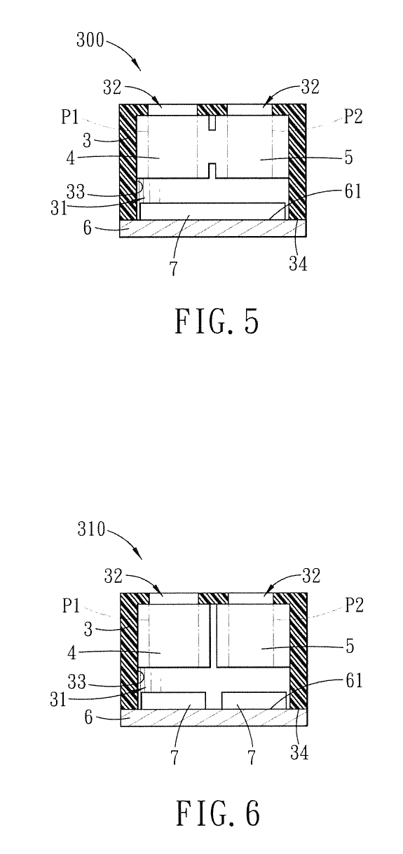

Referring to FIGS. 3 and 4, an image capturing device 300 according to the first preferred embodiment of the present invention comprises a base 3, first and second lens units 4, 5, a circuit board 6, and a sensor element 7.

The base 3 may be cylindrical or square shaped, and is made of plastic. In this embodiment, the base 3 is cross-sectionally U-shaped, defines a receiving space 31, and has a bottom end 34 that is open, and a top end formed with two spaced-apart through holes 32 for fluid communication of the receiving space 31 with an area external to the base 3.

The first and second lens units 4, 5 are disposed within the receiving space 31, are arranged side-by side in a left-right manner, and are located corresponding in position with the through holes 32. In this embodiment, the first and second lens units 4, 5 are affixed to an inner wall face 33 of the base 3 through an adhesive. The first lens unit 4 defines a first light communicating path (P1) corresponding in position with one of the through holes 32. The second lens unit 5 defines a second light communicating path (P2) corresponding in position with the other one of the through holes 32. Through such a configuration, light rays at the area external to the base 3 can pass through the first and second light communicating paths (P1, P2) through the respective through holes 32. The first and second light communicating paths (P1, P2) are parallel to each other (shown in FIG. 4 in imaginary lines) in an extended direction and in the area external to the base 3.

A top face 61 of the circuit board 6 is fixed to the bottom end 34 of the base 3 through an adhesive. The sensor element 7 is welded to the top face 61 of the circuit board 6, and is connected electrically to the circuit board 6. The sensor element 7 is disposed within the receiving space 31 spaced apart from and below the first and second lens units 4, 5, and is used for detecting light rays that pass through the first and second light communicating paths (P1, P2), and then transmitting a detection signal to the circuit board 6.

FIG. 4 is a schematic view, illustrating how the image capturing device 300, which is applied to an electronic device (not shown) to capture an image of an object 8, forms an image of the object 8. Two intersecting lines (L1) passing through the first light communicating path (P1) and the respective through hole 32 define therebetween a viewable region (Z1) of the first lens unit 4. Two intersecting lines (L2) passing through the second light communicating path (P2) and the respective through hole 32 define therebetween a viewable region (Z2) of the second lens unit 5. An image of the object 8 located within an overlapping region (Z3) of the viewable regions (Z1, Z2) of the first and second lens units 4, 5 can be formed on the sensor element 7 through the first and second lens units 4, 5.

For example, when the object 8 moves from a first position (D1) to a second position (D2) or a third position (D3), or when the object 8 moves from the second position (D2) to the first position (D1) or the third position (D3), the position of the image of the object 8 formed on the sensor element 7 through the first and second lens units 4, 5 varies. The sensor element 7 transmits the captured image data to a computing unit (not shown) of the electronic device through the circuit board 6 so as to differentiate between the coordinate position and the change in the coordinate position of the object 8 in three dimensional space.

To manufacture the image capturing device 300 of this embodiment, one method is to form the base 3 first, after which the base 3 is inverted, and the first and second lens units 4, 5 are disposed within the receiving space 31 of the base 3. The circuit board 6, which is welded with the sensor element 7, is then adhered to the bottom end 34 of the base 3 to thereby complete manufacture of the image capturing device 300. Another method of manufacturing the image capturing device 300 is to form the base 3 on the first and second lens units 4, 5 and the circuit board 6, which is welded with the sensor element 7, by an insert molding process. During manufacture of the image capturing device 300, the first and second lens units 4, 5 are simultaneously assembled within the receiving space 31 of the base 3, and the completed image capturing device 300 can be directly installed on the electronic device. Hence, in comparison with the conventional technique, the number of assembly steps of the present invention can be reduced, assembly time can be shortened, and the size of the image capturing device 300 can be reduced so that the image capturing device 300 does not occupy a large space in the electronic device. Further, by installing the first and second lens units 4, 5 to the same base 3, in comparison with the conventional technique, provision of an additional base, an additional circuit board, and an additional sensor element is not necessary so that the manufacturing cost thereof can be minimized. As a result, the production cost of the image capturing device 300 can be reduced to a large extent. Moreover, since the first and second lens units 4, 5 are installed simultaneously within the base 3, assembly and positioning precision of the first and second lens units 4, 5 can be effectively enhanced, so that accuracy of the image capturing device 300 after assembly on the electronic device may also be achieved.

It is worth mentioning that the structure of the first and second lens units 4, 5 may be modified according to actual requirements. For example, each of the first and second lens unit 4, 5 may include a single lens, or a plurality of lenses that are spaced apart from each other in a top-bottom direction; the number of lenses of the first and second lens units 4, 5 maybe the same or different; the first and second lens units 4, 5 may be formed separately or connected integrally to each other as one piece; the lenses of the first and second lens units 4, 5 may have concaved, convexed, or flat surfaces, and the curvature parameter of the lenses maybe the same or different; and the material of the lenses of the first and second lens unit 4, 5 may be the same or different.

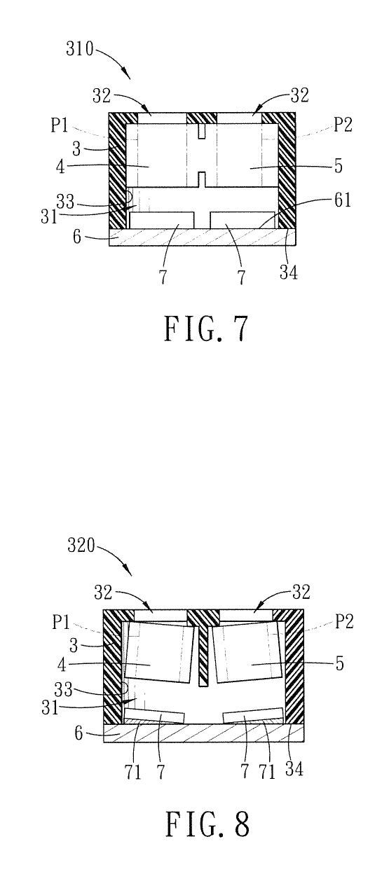

Referring to FIG. 6, the use and manufacturing method of an image capturing device 310 according to the second preferred embodiment of this invention are similar to those described in relation to the first preferred embodiment. The difference resides in that the image capturing device 310 comprises two sensor elements 7 welded to the top face 61 of the circuit board 6 and are spaced apart from and disposed below the first and second. lens units 4, 5. The sensor elements 7 are used for detecting light rays that pass through the first and second light communicating paths (P1, 62), respectively. Further, during manufacture of the image capturing device 310, the first and second lens units 4, 5 may be connected integrally to each other as one piece, as shown in FIG. 7, and may be fixed to the inner wall face 33 of the base 3 through use of an adhesive.

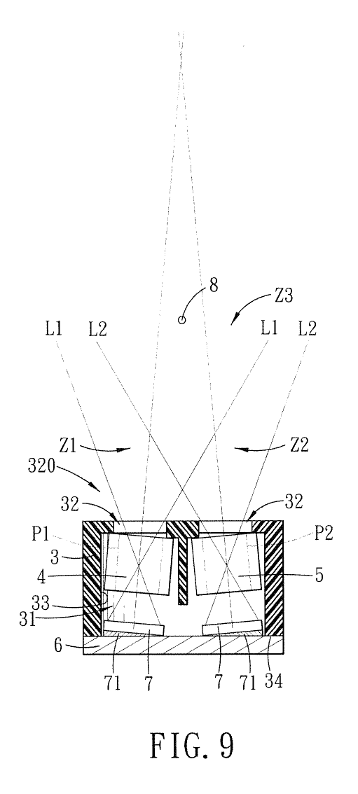

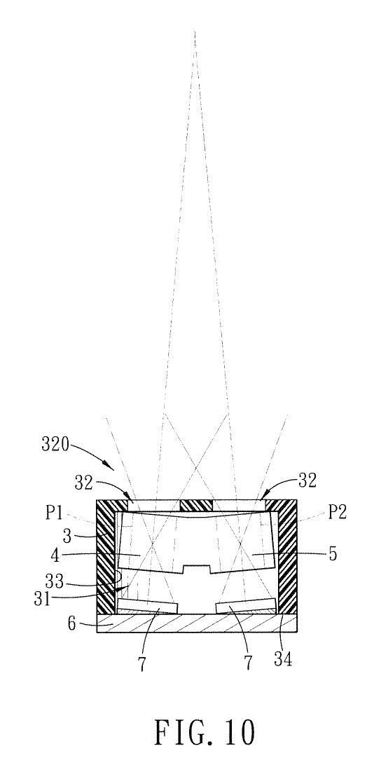

Referring to FIGS. 8 and 9, an image capturing device 320 according to the third preferred embodiment of this invention is shown to be similar to the second preferred embodiment. The difference resides in that the first and second lens units 4, 5 and the two sensor elements 7 are inclined inwardly so that the first and second light communicating paths (P1, P2) intersect each other in the extended direction (shown in FIG. 9 in imaginary lines) and in the area external to the base 3. Each sensor element 7 is adhered to the circuit board 6 through an adhesive 71. Through such a configuration, the overlapping region (Z3) of the viewable regions (Z1, Z2) of the first and second lens units 4, 5 has a larger range as compared to that of the second preferred embodiment, so that the region of the object 8, which is formed on each sensor element 7, is larger, and differentiation between the coordinate position and the change in the coordinate position of the object 8 in three dimensional space can be effectively and accurately realized. Further, during manufacture of the image capturing device 320, the first and second lenses 41, 51 can be connected integrally to each other as one piece, as shown in FIG. 10, and can be adhered to the inner wall face 33 of the base 3 through use of an adhesive.

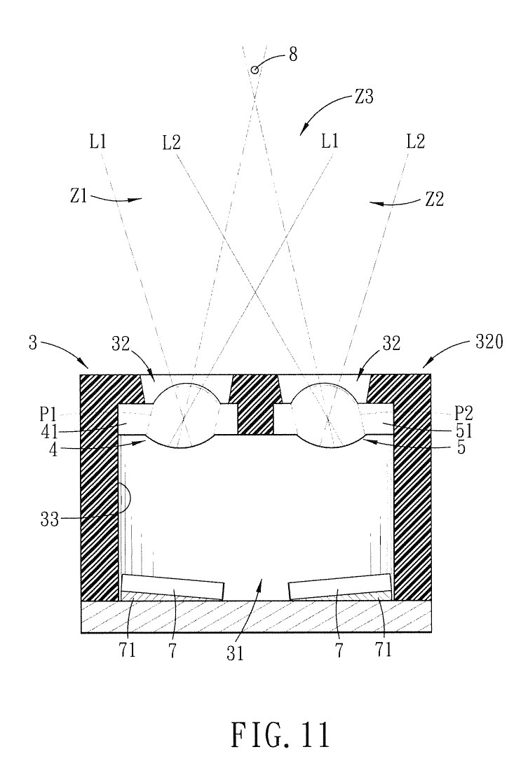

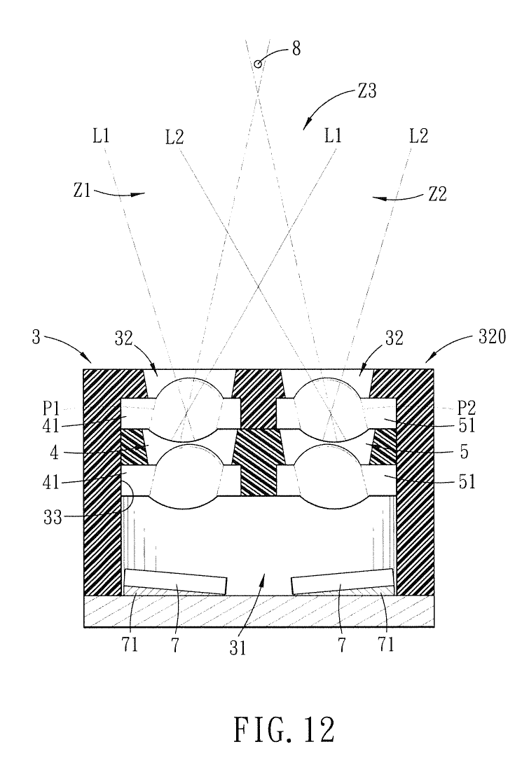

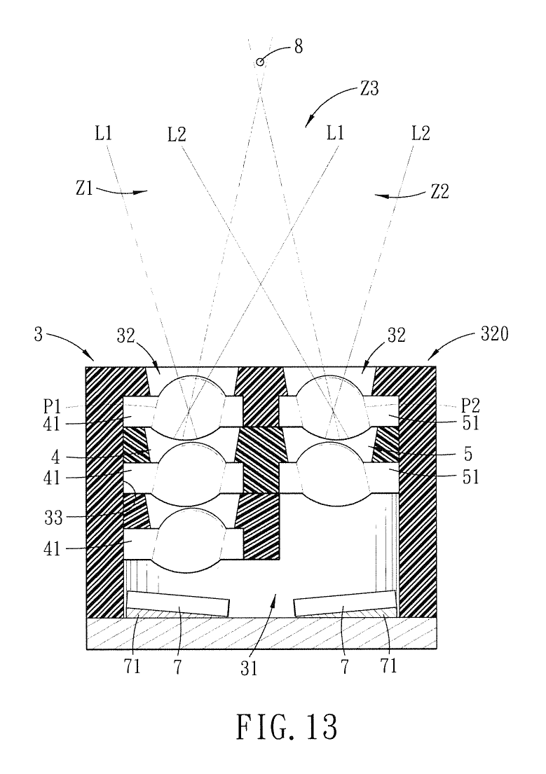

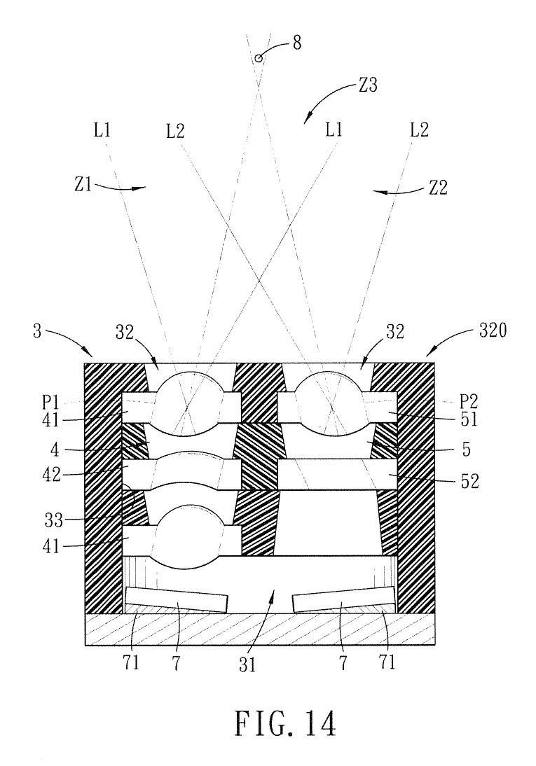

It is worth mentioning that the structure of the first and second lens units 4, 5 may be modified according to actual requirements. For example, each of the first and second lens unit 4, 5 may include a single lens 41, 51, as shown in FIG. 11, so as to save production costs, or a plurality of lenses 41, 51 that are spaced apart from each other in a top-bottom direction, as shown in FIG. 12, so as to improve the image resolution. Further, the number of lenses 41, 51 of the first and second lens units 4, 5 may be the same, as shown in FIG. 12, or different, as shown in FIG. 13, depending on actual requirements so as to increase the design and manufacturing flexibility of the image capturing device of the present invention. The first and second lens units 4, 5 may be formed separately (see FIGS. 8 and 9) or connected integrally to each other as one piece (see FIG. 10). Moreover, the lenses 41, 42, 51, 52 of the first and second lens units 4, 5 may have concaved, convexed, or flat surfaces, as shown in FIG. 14, which can similarly increase the design and manufacturing flexibility of the image capturing device of the present invention, and the curvature parameter of the lenses may be the same or different. Additionally, the material of the lenses of the first and second lens unit 4, 5 may be the same or different.

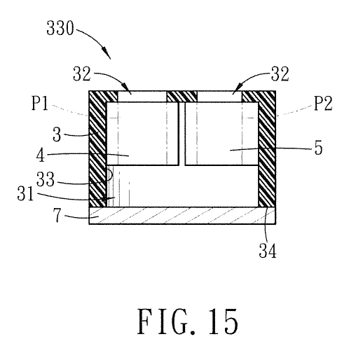

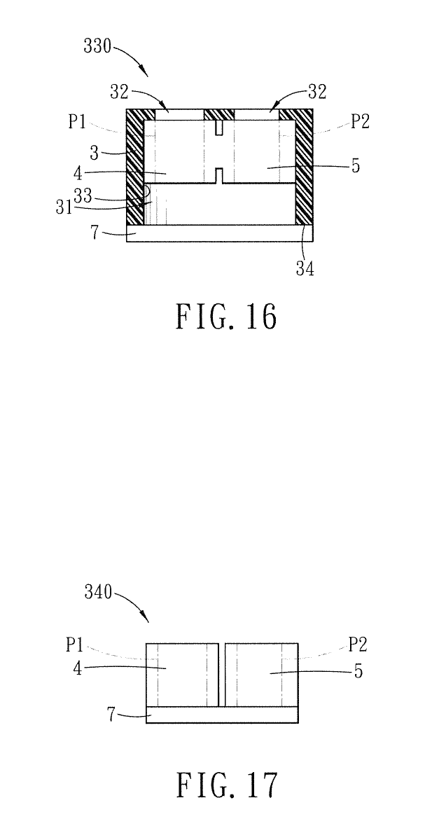

Referring to FIG. 15, the use and manufacturing method of an image capturing device 330 according to the fourth preferred embodiment of the present invention are similar to those described in relation to the first preferred embodiment. The difference resides in that the image capturing device 330 dispenses with the need for the circuit board 6 shown in FIG. 3, and the sensor element 7 is fixed to the bottom end 34 of the base 3 through an adhesive. The sensor element 7 is spaced apart from and is disposed below the first and second lens units 4, 5. Moreover, during manufacture of the image capturing device 330, the first and second lens units 4, 5 may be connected integrally to each other as one piece, as shown in FIG. 16, and may be fixed to the inner wall face 33 of the base 3 through use of an adhesive.

FIG. 17 illustrates an image capturing device 340 according to the fifth preferred embodiment of the present invention. The components and manufacturing method of the image capturing device 340 are different from those of the first preferred embodiment. The difference resides in that the image capturing device 340 is configured as a wafer level module, and the base 3 and the circuit board 6 shown in FIG. 3 are omitted.

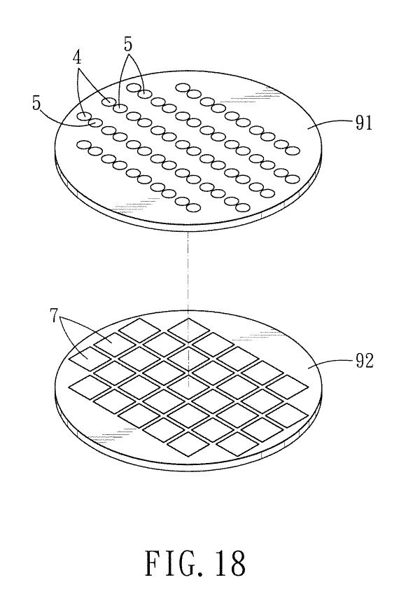

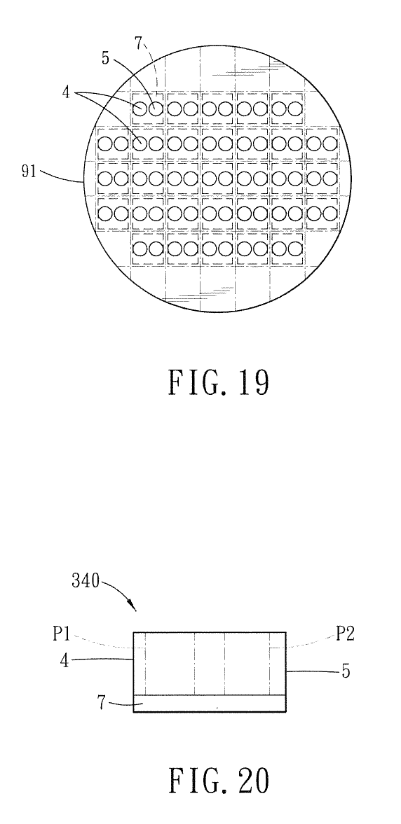

With reference to FIGS. 18 and 19, two methods of manufacturing the image capturing device 340 are stated herein. In the first method, a wafer 91, which is made of glass and which is formed with a plurality of sets of first and second lens units 4, 5, and another wafer 92, which is made of glass and which is formed with a plurality of sensor elements 7, are disposed one above the other so that each set of the first and second lens units 4, 5 is disposed on a top face of a corresponding one of the sensor elements 7, and is adhered thereto through an adhesive. Afterwards, each set of the first and second lens units 4, 5 and the corresponding sensor element 7 are cut from the overlapping wafers 91, 92 in a top-to-bottom direction, thereby forming a plurality of the image capturing devices 340. Since the first and second lens units 4, 5 in the wafer 91 are spaced apart from each other in a left-to-right manner, the first and second lens units 4, 5 of the completed image capturing device 340 are adhered to the sensor element 7 also in a left-to-right manner. In another method, each set of first and second lens units 4, 5 is cut from the wafer 91, and each sensor element 7 is cut from the wafer 92, after which each set of the first and second lens units 4, 5 is adhered to one of the sensor elements 7 by using an adhesive, thereby forming a plurality of the image capturing devices 340.

During manufacture of the image capturing device 340, the first and second lens units 4, 5 of the wafer 91 may be designed to be connected to each other so that the first and second lens units 4, 5 of each formed image capturing device 340 are connected integrally to each other as one piece, as shown in FIG. 20.

It is worth mentioning that when the lenses of the first and second lens units 4, 5 are different, during manufacture of the image capturing device 340, a spacer (not shown) may be provided between the first lens unit 4 and the sensor element 7 or between the second lens unit 5 and the sensor element 7, so that the first or second lens unit 4, 5 is spaced apart from the sensor element 7.

In summary, through the first and second lens units 4, 5 which are arranged in a left-right manner and which respectively define the first and second light communicating paths (P1, P2) so that the sensor element(s) 7 can detect light rays passing through the first and second light communicating paths (P1, P2), the image capturing device 300, 310, 320, 330, 340 of each embodiment involves a reduced number of steps during assembly so as to shorten assembly time, thereby reducing the manufacturing costs thereof to a large extent. Further, assembly and positioning precision of the first and second lens units 4, 5 can be effectively enhanced, so that accuracy of the image capturing device 300, 310, 320, 330, 340 may also be achieved after being assembled on the electronic device. Hence, the object of the present invention can be achieved.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. An image capturing device, comprising:
a base defining a receiving space and having two spaced-apart through holes for fluid communication of said receiving space with an area external to said base;
a first lens unit disposed within said receiving space and defining a first light communicating path that corresponds in position with one of said through holes;
a second lens unit disposed within said receiving space in a side-by-side manner with said first lens unit, said second lens unit defining a second light communicating path that corresponds in position with the other one of said through holes;
a circuit board connected to a bottom end of said base; and
two spaced-apart sensor elements that are disposed on a top face of said circuit board and that are spaced apart from and disposed below said first and second lens units, said sensor elements being used to detect light rays that pass through said first and second light communicating paths, respectively;
wherein said first lens unit, said second lens unit and said sensor elements are inclined inwardly, so that said first and second light communicating paths intersect each other in an extended direction and in the area external to said base.

2. The image capturing device of claim 1, wherein said first and second lens units are connected integrally to each other as one piece, and are fixed to said base.

3. The image capturing device of claim 1, wherein said first and second lens units are spaced apart from each other in a left-right manner, and are fixed separately to said base.

4. The image capturing device of claim 1, wherein each of said first and second lens units includes a single lens.

5. The image capturing device of claim 1, wherein each of said first and second lens units includes a plurality of lenses that are spaced apart from each other in a top-bottom direction.

6. The image capturing device of claim 5, wherein the number of lenses of said first and second lens units are the same.

7. The image capturing device of claim 5, wherein the number of lenses of said first and second lens units are different.

8. The image capturing device of claim 5, wherein said lenses of said first and second lens units have concaved, convexed or flat surfaces.

9. The image capturing device of claim 1, wherein said base is cross-sectionally U-shaped, and said first lens unit is affixed to an interior wall of said base.
